(19) United States
(12) Patent Application Publication
(10) Pub. No.: US 2026/0292859 A1
(43) Pub. Date: Sep. 24, 2026

(54) INDICATION METHOD AND APPARATUS, DEVICE, AND STORAGE MEDIUM

(71) Applicant: BEIJING XIAOMI MOBILE SOFTWARE CO., LTD., Beijing (CN)

(72) Inventor: Shengxiang GUO, Beijing (CN)

(21) Appl. No.: 19/168,777

(22) PCT Filed: Mar. 27, 2023
(86) PCT No.: PCT/CN2023/084193

§ 371 Date: Sep. 24, 2025

(51) Int. Cl. H04W 72/50; H04W 72/1263

(52) U.S. Cl. CPC H04W 72/535; H04W 72/1263

(57) ABSTRACT

An indication method, executed by a terminal, includes: in the case that one configured grant (CG) period includes a plurality of transmission occasions (TOs), sending indication information to a network device, wherein the indication information indicates a usage status of the TOs, and the usage status comprises: used or unused.

### CROSS-REFERENCE TO RELATED APPLICATION

This application is a U.S. national phase of International Application No. PCT/CN2023/084193, filed on Mar. 27, 2023, the entire content of which is incorporated herein by reference.

### TECHNICAL FIELD

The disclosure relates to the field of wireless communication technologies, and in particular to an indication method and apparatus, a device, and a storage medium.

### BACKGROUND

In a wireless communication system, a network device usually needs to configure a configured grant (CG) period for a terminal. The CG period may include multiple transmission occasions (TOs). The terminal may select some or all of the TOs in the CG period for uplink transmission. Alternatively, when there is a TO unused by the terminal in the CG period, the network device may schedule the TO unused by the terminal for reuse for uplink transmission of other terminals, thus improving the uplink transmission efficiency. In this case, the terminal needs to indicate a usage status of the TO in the CG period to the network device, such that the network device may schedule the unused TO for reuse based on the usage status of the TO in the CG period. Therefore, an indication method is needed.

### SUMMARY

In a first aspect, embodiments of the disclosure provide an indication method, including:
in the case that one configured grant (CG) period includes multiple transmission occasions (TOs), sending indication information to a network device, in which the indication information indicates a usage status of the TOs, and the usage status includes: used or unused.

In a second aspect, embodiments of the disclosure provide an indication method, including:
receiving indication information sent by a terminal, in which the indication information is sent to the network device by the terminal in the case that one CG period includes multiple TOs, the indication information indicates a usage status of the TOs, and the usage status includes: used or unused.

In a third aspect, embodiments of the disclosure provide a terminal, including: a processor and a memory for storing instructions executable by the processor. The processor is configured to execute the method of the first aspect.

In a fourth aspect, embodiments of the disclosure provide a network device, including: a processor and a memory for storing instructions executable by the processor. The processor is configured to execute the method of the second aspect.

### BRIEF DESCRIPTION OF THE DRAWINGS

The above-mentioned and/or additional aspects and advantages of the disclosure will become apparent and readily appreciated from following description of embodiments, taken in combination with the accompanying drawings.

FIG. 1 is a schematic diagram illustrating an architecture of some communication systems according to an embodiment of the disclosure.

FIG. 2 is a flow chart illustrating an indication method executed by a terminal according to another embodiment of the disclosure.

FIG. 3 is a flow chart illustrating an indication method according to still another embodiment of the disclosure.

FIG. 4 is a flow chart illustrating an indication method according to still another embodiment of the disclosure.

FIG. 5 is a flow chart illustrating an indication method according to still another embodiment of the disclosure.

FIG. 6 is a flow chart illustrating an indication method according to still another embodiment of the disclosure.

FIG. 7 is a flow chart illustrating an indication method executed by a network device according to an embodiment of the disclosure.

FIG. 8 is a flow chart illustrating an indication method according to another embodiment of the disclosure.

FIG. 9 is a flow chart illustrating an indication method according to still another embodiment of the disclosure.

FIG. 10 is a flow chart illustrating an indication method according to still another embodiment of the disclosure.

FIG. 11 is a flow chart illustrating an indication method according to still another embodiment of the disclosure.

FIG. 12 is a flow chart illustrating an indication method according to still another embodiment of the disclosure.

FIG. 13 is a block diagram illustrating a communication apparatus according to an embodiment of the disclosure.

FIG. 14 is a block diagram illustrating a communication apparatus according to an embodiment of the disclosure.

FIG. 15 is a block diagram illustrating a communication device according to an embodiment of the disclosure.

FIG. 16 is a block diagram illustrating a chip according to an embodiment of the disclosure.

### DETAILED DESCRIPTION

Description will be made here in detail to the exemplary embodiments, examples of which are illustrated in the accompanying drawings. When the following description refers to the accompanying drawings, the same numerals in different drawings refer to the same or similar elements unless otherwise indicated. The implementations described in the following exemplary embodiments do not represent all implementations consistent with embodiments of the disclosure. Instead, they are merely examples of devices and methods consistent with some aspects of embodiments of the disclosure as recited in the appended claims.

Terms used in embodiments of the disclosure are for the purpose of describing specific embodiments only, and are not intended to limit embodiments of the disclosure. As used in embodiments of the disclosure and the appended claims, the singular forms “a/an” and “the” are also intended to include the plural forms unless the context clearly dictates otherwise. It should also be understood that the term “and/or” as used herein refers to and includes any and all possible combinations of one or more associated listed items.

It should be understood that although embodiments of the disclosure may use the terms such as first, second, third, etc. to describe various information, the information should not be limited to these terms. These terms are only used to distinguish information of the same type from one another. For example, without departing from the scope of embodiments of the disclosure, first information may also be called second information, and similarly, second information may also be called first information. Depending on the context, the word “if” and “in case” as used herein may be interpreted as “in the case that” or “when” or “in response to a determination”.

Embodiments of the disclosure are described in detail below, and examples of the embodiments are illustrated in the accompanying drawings, throughout which the same or similar symbols indicate the same or similar elements. The embodiments described below with reference to the accompanying figures are exemplary and are intended to be used to explain the disclosure and are not to be construed as a limitation of the disclosure.

In the related art, a method for a terminal to indicate a usage status of a transmission occasions (TO) in a configured grant (CG) period to a network device may include at least one of the following:

Method 1: the terminal sends indication information to the network device, in which the indication information may indicate at least one consecutive unused TO, or the indication information may indicate a consecutive time window, and all TOs within the time window are unused TOs.

Method 2: the terminal sends indication information to the network device, in which the indication information is a bit bitmap, each bit in the bit bitmap corresponds to one TO, and a bit value carried by each bit indicates the usage status of the TO corresponding to the bit; or, each bit in the bit bitmap corresponds to one time window, and a bit value carried by each bit indicates the usage status of the TO in the time window corresponding to the bit.

However, the method 1 has a poor flexibility, and the method 2 has a large signaling overhead. Further, the method for determining a start position of the time window is not clear when the usage status of the TO in the time window is indicated in both the method 1 and the method 2.

Based on the above, the disclosure provides an indication method.

In order to better understand the indication method in embodiments of the disclosure, a communication system to which embodiments of the disclosure are applicable is described below.

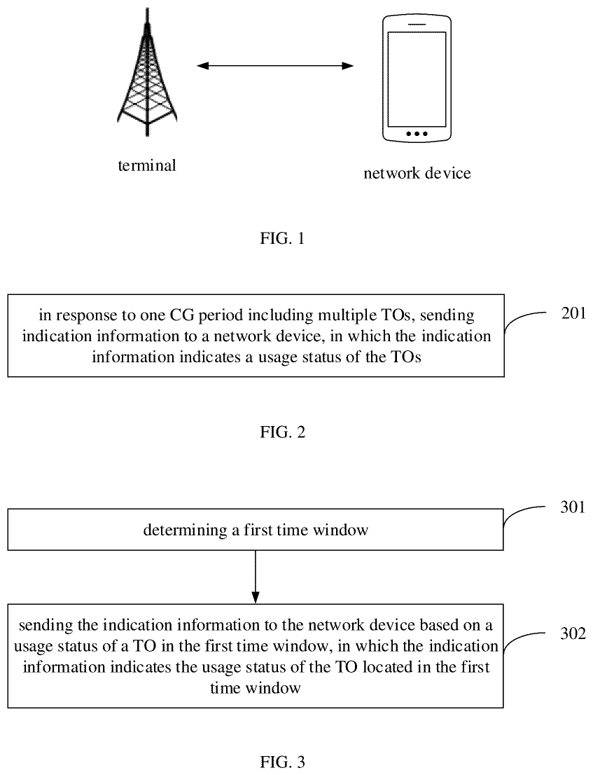

FIG. 1 is a schematic diagram illustrating an architecture of a communication system according to an embodiment of the disclosure. The communication system may include, but is not limited to, at least one terminal and at least one network device. The number and forms of devices illustrated in FIG. 1 are only for example and do not constitute a limitation to embodiments of the disclosure, and one or more terminals and one or more network devices may be included in a practical application. The communication system as illustrated in FIG. 1 includes one terminal and one network device for example.

It needs to be noted that the technical solution in embodiments of the disclosure is applicable to various communication systems, such as a long term evolution (LTE) system, a 5th generation (5G) mobile communication system, a 5G new radio (NR) system or other future new mobile communication systems.

The network device in embodiments of the disclosure is an entity, at a network side, for transmitting or receiving a signal. For example, the network device may be an evolved NodeB (eNB), a transmission reception point (TRP), a radio remote head (RRH), a next generation NodeB (gNB) in a NR system, a base station in other future mobile communication systems, an access node in a wireless networking (Wi-Fi™) system, or the like. A detailed technology and a detailed device form employed by the network device are not limited in embodiments of the disclosure. The base station according to embodiments of the disclosure may consist of a central unit (CU) and a distributed unit (DU). The CU may also be referred to as a control unit. The base station, such as protocol layers, may be split by using a structure of the CU-DU, functions of a part of the protocol layers are placed in the CU for central control, and functions of a remaining part or all of the protocol layers are distributed in the DU, and the DU is centrally controlled by the CU.

The terminal in embodiments of the disclosure is an entity, at a user side, for receiving or transmitting a signal, such as, a mobile phone. The terminal may also be referred to as a terminal device, a user equipment (UE), a mobile station (MS), a mobile terminal (MT), etc. The terminal may be a device with a communication function, such as a vehicle, a smart vehicle, a mobile phone, a wearable device, a tablet (Pad), a computer with a wireless transceiving function, a virtual reality (VR) terminal, an augmented reality (AR) terminal, a wireless terminal in industrial control, a wireless terminal in self-driving, a wireless terminal in a remote medical surgery, a wireless terminal in a smart grid, a wireless terminal in transportation safety, a wireless terminal in a smart city, a wireless terminal in a smart home, etc. A detailed technology and a detailed device form employed by the terminal are not limited in embodiments of the disclosure.

It may be understood that, the communication system described in embodiments of the disclosure is intended to explain a technical solution of embodiments of the disclosure more clearly, and does not constitute a limitation to the technical solution provided by embodiments of the disclosure. Those skilled in the art may know that, with evolution of a system architecture and emergence of a new service scenario, the technical solution provided in embodiments of the disclosure are also applicable to similar technical problems.

In addition, the following points are explained to facilitate understanding of embodiments of the disclosure.

First, in the disclosure, without conflict, each step in any implementation or embodiment may be implemented as an independent embodiment; and any step may be combined arbitrarily. For example, a solution obtained by removing some steps from a certain implementation or embodiment may also constitute an independent embodiment; and a sequence of steps within a certain implementation or embodiment may be exchanged arbitrarily. In addition, alternative ways or examples within a certain implementation or embodiment may be combined arbitrarily. In addition, respective implementations or embodiments may be combined arbitrarily. For example, some or all steps from different implementations or embodiments may be combined arbitrarily; a certain implementation or embodiment may be combined with alternative ways or alternative examples of other implementations or embodiments.

Second, regarding a record way in the disclosure, such as: “A or B”, “A and/or B”, “at least one of A and B”, “in one case A, in another case B”, “in response to one case A, in response to another case B”, at least one of the following solutions may be included based on an actual condition, that is, executing A irrespective of B, i.e., executing A in some implementations; executing B irrespective of A, i.e., executing B in some implementations; selectively executing A and B, i.e., selecting execution from A and B in some implementations; or executing both A and B, i.e., executing A and B in some implementations.

Third, each element, row, or column in a table involved in the disclosure may be implemented as an independent embodiment; a combination of any element, row, or column may be implemented as an independent embodiment.

Fourth, in some implementations or embodiments, “including A”, “containing A”, “for indicating A”, or “carrying A” in the disclosure may be interpreted as directly carrying A, or may be interpreted as indirectly indicating A.

Fifth, in some implementations or embodiments, expressions such as “in response to . . . ”, “in a case that . . . ”, “when . . . ”, “if . . . ”, “in case . . . ”, etc., in the disclosure may be used interchangeably.

FIG. 2 is a flow chart illustrating an indication method according to an embodiment of the disclosure. The method is executed by a terminal. As illustrated in FIG. 2, the indication method may include the following.

At block 201, in response to one CG period including multiple TOs, indication information is sent to a network device, in which the indication information is used to indicate a usage status of the TOs, and the usage status may include: used or unused.

Alternatively, in an embodiment of the disclosure, the CG period above may be configured by the network device, for example, the network device may configure the CG period via a radio resource control (RRC) signaling. Alternatively, the network device may configure at least one CG period for the terminal. Further, after the terminal receives the CG period configured by the network device, the terminal may autonomously determine which TOs in the CG period are used for uplink transmission. Alternatively, the terminal may select to use at least some of the TOs in the CG period for the uplink transmission, and remaining TOs are considered unused by the terminal. Alternatively, for the “used TOs” selected by the terminal, the terminal may use the used TOs for the uplink transmission, or may not use the used TOs for the uplink transmission; but for the “unused TOs” selected by the terminal, the terminal does not use the unused TOs for the uplink transmission.

Alternatively, after the terminal determines the TOs that the terminal intends to use, in an embodiment of the disclosure, the terminal may send the indication information to the network device based on the usage status of the TOs. Alternatively, the indication information may indicate, for example, which TOs in the CG period configured by the network device are unused, or the indication information may indicate, for example, which TOs in the CG period configured by the network device are used, in which TOs in the CG period other than the TOs used by the terminal are the TOs unused by the terminal.

Thus, the network device may determine which TOs in the CG period configured for the terminal are unused by the terminal based on the indication information, and then the network device may schedule and reuse the TOs not used by the terminal for other uplink transmissions, thus improving the efficiency of the uplink transmission.

Alternatively, in an embodiment of the disclosure, the indication information may be sent to the network device in any one or more TOs (e.g., used TOs) by an uplink control information (UCI) signaling. Alternatively, the UCI may be a CG-UCI or a new UCI, and the UCI may be carried by a CG physical uplink shared channel (PUSCH).

In conclusion, with the indication method according to the embodiments of the disclosure, when one CG period includes the multiple TOs, the terminal sends the indication information to the network device, in which the indication information indicates the usage status of the TOs, and the usage status includes: used or unused. Thus, it can be known that, the disclosure provides an indication method for the terminal to indicate the usage status of the TOs in the CG period to the network device, thus the network device may reuse the unused TOs for other uplink transmissions after learning about which TOs in the CG period are not used by the terminal, thus ensuring the efficiency of the uplink transmission.

FIG. 3 is a flow chart illustrating an indication method according to an embodiment of the disclosure. The method is executed by a terminal. As illustrated in FIG. 3, the indication method may include the following.

At block 301, a first time window is determined.

Alternatively, in an embodiment of the disclosure, the first time window may be understood as a valid time window corresponding to indication information sent by the terminal, that is, the indication information specifically indicates a usage status of a TO within the first time window.

Alternatively, in an embodiment of the disclosure, the above method for determining the first time window may include: determining the first time window based on protocol pre-definition and/or configuration of the network device.

Alternatively, in an embodiment of the disclosure, the first time window determined based on the protocol pre-definition may include one CG period. For example, the first time window may include: a CG period where a CG PUSCH carrying the indication information is located; or, the first time window may include: a next CG period following the CG period where the CG PUSCH carrying the indication information is located.

In another embodiment of the disclosure, the first time window determined based on the protocol pre-definition may include at least two CG periods overlapped in a time domain. For example, the first time window may include: a CG period where the CG PUSCH carrying the indication information is located and a next CG period following the CG PUSCH, and the two CG periods overlap in the time domain. In this case, time units included in the first time window are: time units from a start time unit of the CG period where the CG PUSCH carrying the indication information is located to an end time unit of the next CG period following the CG PUSCH. Alternately, the first time window may include: two next CG periods following the CG period where the CG PUSCH carrying the indication information is located, and the two CG periods overlap in the time domain. In this case, time units included in the first time window are: time units from a start time unit of the first next CG period following the CG period where the CG PUSCH carrying the indication information is located to an end time unit of the second next CG period following the CG period where the CG PUSCH carrying the indication information is located.

In another embodiment of the disclosure, the first time window determined based on the protocol pre-definition may include at least two CG periods non-overlapped in a time domain. For example, the first time window may include: a CG period where the CG PUSCH carrying the indication information is located and a next CG period following the CG period, and the two CG periods do not overlap in the time domain. Alternatively, the first time window may include: two next CG periods following the CG period where the CG PUSCH carrying the indication information is located, and the two CG periods do not overlap in the time domain. It should be noted that when the first time window includes the at least two CG periods non-overlapped in the time domain, a time interval between adjacent CG periods in the at least two CG periods non-overlapped in the time domain may or may not be included in the first time window. Alternatively, when the time interval between the adjacent CG periods in the at least two CG periods non-overlapped in the time domain is included in the first time window, time units included in the first time window are: time units from a start time unit of the first CG period in the at least two CG periods non-overlapped in the time domain to an end time unit of the last CG period in the at least two CG periods non-overlapped in the time domain. When the time interval between the adjacent CG periods in the at least two CG periods non-overlapped in the time domain is not included in the first time window, time units included in the first time window are: time units respectively occupied by each CG period of the at least two CG periods non-overlapped in the time domain.

In another embodiment of the disclosure, the first time window determined based on the protocol pre-definition may include at least one radio frame. For example, the first time window may include: the radio frame where the CG PUSCH carrying the indication information is located.

In another embodiment of the disclosure, the first time window determined based on the protocol pre-definition may include at least radio half-frame. For example, the first time window may include: the radio half-frame where the CG PUSCH carrying the indication information is located.

In another embodiment of the disclosure, the first time window determined based on the protocol pre-definition may include at least one TO. For example, the first time window may include: any one or more of all TOs in the CG period where the CG PUSCH carrying the indication information is located. Alternatively, the first time window may include: any one or more of all TOs in the CG period where the CG PUSCH carrying the indication information is located, the all TOs including TOs excluding the TOs where the CG PUSCH carrying the indication information is located.

In another embodiment of the disclosure, the first time window determined based on the protocol pre-definition may include at least one time-domain symbol. For example, the first time window may include: a segment of consecutive uplink time-domain symbols. Alternatively, the first time window may include: a segment of non-consecutive uplink time-domain symbols.

In another embodiment of the disclosure, the first time window determined based on the protocol pre-definition may include at least one slot. For example, the first time window may include: multiple consecutive uplink slots. Alternatively, the first time window may include: multiple non-consecutive uplink slots.

Alternatively, it should be noted that when the terminal determines the first time window based on the configuration of the network device, the network device may send a first configuration signaling (e.g., an RRC signaling) to the terminal. The first configuration signaling may configure a time length of the first time window. For example, the first configuration signaling may configure the time length of the first time window as one CG period; or, N CG periods overlapped in the time domain, where N is greater than or equal to 2; or, N CG periods non-overlapped in the time domain; or, M radio frames, where M is greater than or equal to 1; or, L radio half-frames, where L is greater than 1; or, K TOs, where K is greater than 1; or, Q time-domain symbols, where Q is greater than 1; or, W slots, where W is greater than 0. Alternatively, when the time length of the first time window configured by the first configuration signaling is one CG period, the terminal may determine that the first time window includes: the CG period where the CG PUSCH carrying the indication information is located; or, the next CG period following the CG period where the CG PUSCH carrying the indication information is located. When the time length of the first time window configured by the first configuration signaling is N CG periods overlapped in the time domain, the terminal may determine that the first time window includes: any N CG periods overlapped in the time domain among the CG period where the CG PUSCH carrying the indication information is located and all subsequent CG periods following the CG period. When the time length of the first time window configured by the first configuration signaling is N CG periods non-overlapped in the time domain, the terminal may determine that the first time window includes: any N CG periods non-overlapped in the time domain among the CG period where the CG PUSCH carrying the indication information is located and all subsequent CG periods following the CG period. When the time length of the first time window configured by the first configuration signaling is M radio frames, the terminal may determine that the first time window includes: any M radio frames among the radio frame where the CG PUSCH carrying the indication information is located and all subsequent radio frames following the radio frame. When the time length of the first time window configured by the first configuration signaling is L radio half-frames, the terminal may determine that the first time window includes: any L radio half-frames among the radio half-frame where the CG PUSCH carrying the indication information is located and all subsequent radio half-frames following the radio half-frame. When the time length of the first time window configured by the first configuration signaling is K TOs, the terminal may determine that the first time window includes: any K TOs among the TO where the CG PUSCH carrying the indication information is located and/or all subsequent TOs following the TO. When the time length of the first time window configured by the first configuration signaling is Q time-domain symbols, the terminal may determine that the first time window includes: any consecutive, non-consecutive, or partially consecutive Q time-domain symbols after an end symbol of the CG PUSCH carrying the indication information. When the time length of the first time window configured by the first configuration signaling is Q time-domain symbols, the terminal may determine that the first time window includes: any consecutive, non-consecutive, or partially consecutive Q time-domain symbols after an end symbol of the TO where the CG PUSCH carrying the indication information is located. When the time length of the first time window configured by the first configuration signaling is W slots, the terminal may determine that the first time window includes: any consecutive, non-consecutive, or partially consecutive W slots among the slot where the CG PUSCH carrying the indication information is located and/or subsequent slots following the slot.

Alternatively, in another embodiment of the disclosure, the method for determining the first time window may include: receiving configuration information sent by the network device, and determining the first time window based on the configuration information.

Alternatively, in an embodiment of the disclosure, the above configuration information may include at least one of: a start time unit of the first time window, or an end time unit of the first time window. Alternatively, the time unit may be, such as, at least one of: a slot, a time-domain symbol, a TO, a radio half-frame, or a radio frame.

For example, in an embodiment of the disclosure, the configuration information may include the start time unit and the end time unit. The terminal may determine the first time window based on the start time unit and the end time unit. For example, if the start time unit included in the configuration information is TO1 and the end time unit is TO5, it may be determined that the first time window includes TO1, TO2, TO3, TO4, and TO5.

For example, in another embodiment of the disclosure, the configuration information may include the start time unit, and the terminal may determine the end time unit of the first time window based on the protocol pre-definition. Then, the terminal determines the first time window based on the start time unit and the end time unit. For example, the start time unit included in the configuration information is TO3, and the end time unit of the first time window determined by the terminal based on the protocol pre-definition is: a last TO in the CG period where the CG PUSCH carrying the indication information is located. In the case that the TOs in the CG period where the CG PUSCH carrying the indication information is located are TO0, TO1, TO2, TO3, TO4, TO5, TO6, and TO7, it may be determined that the first time window includes TO3, TO4, TO5, TO6, and TO7.

For example, in another embodiment of the disclosure, the configuration information may include the end time unit, and the terminal may determine the start time unit of the first time window based on the protocol pre-definition. Then, the terminal determines the first time window based on the start time unit and the end time unit. For example, it is assumed that the end time unit included in the configuration information is TO6, and the start time unit of the first time window pre-defined by the protocol is: the TO where the CG PUSCH carrying the indication information is located. In the case that the TO where the CG PUSCH carrying the indication information is located is TO3, it may be determined that the first time window includes TO3, TO4, TO5, and TO6. For another example, the end time unit included in the configuration information is TO6, and the start time unit of the first time window pre-defined by the protocol is: the next TO following the TO where the CG PUSCH carrying the indication information is located. In the case that the TO where the CG PUSCH carrying the indication information is located is TO3, it may be determined that the first time window includes TO4, TO5, and TO6. For another example, it is assumed that the end time unit included in the configuration information is TO6, and the start time unit of the first time window pre-defined by the protocol is: a target TO, in which a time interval between the target TO and the TO where the CG PUSCH carrying the indication information is located meets a preset duration (e.g., a time interval between a start time of the target TO and an end time of the TO where the CG PUSCH carrying the indication information is located meets a preset duration). In the case that the target TO is TO5, it may be determined that the first time window includes TO5 and TO6.

Alternatively, in an embodiment of the disclosure, the above configuration information may include at least one of: the start time unit of the first time window, or a time length of the first time window.

For example, in an embodiment of the disclosure, the configuration information may include the start time unit and the time length of the first time window. The terminal may determine the first time window based on the start time unit and the time length of the first time window. For example, it is assumed that the start time unit included in the configuration information is TO1 and the time length of the first time window is 5 TOs, it may be determined that the first time window includes TO1, TO2, TO3, TO4, and TO5.

For example, in another embodiment of the disclosure, the configuration information may include the start time unit, and the terminal may determine the time length of the first time window based on the protocol pre-definition. Then, the terminal determines the first time window based on the start time unit and the time length of the first time window. For example, it is assumed that the start time unit included in the configuration information is TO3, and the time length of the first time window determined by the terminal based on the protocol pre-definition is 5 TOs. Then, it may be determined that the first time window includes TO3, TO4, TO5, TO6, and TO7.

For example, in another embodiment of the disclosure, the configuration information may include the time length of the first time window, and the terminal may determine the start time unit of the first time window based on the protocol pre-definition. Then, the terminal determines the first time window based on the start time unit and the time length of the first time window. For example, the time length of the first time window included in the configuration information is 4 TOs, and the start time unit of the first time window pre-defined by the protocol is: the TO where the CG PUSCH carrying the indication information is located. In the case that the TO where the CG PUSCH carrying the indication information is located is TO3, it may be determined that the first time window includes TO3, TO4, TO5, and TO6. For another example, the time length of the first time window included in the configuration information is 3 TOs, and the start time unit of the first time window based on the protocol pre-definition is: the next TO following the TO where the CG PUSCH carrying the indication information is located. In the case that the TO where the CG PUSCH carrying the indication information is located is TO3, it may be determined that the first time window includes TO4, TO5, and TO6. For another example, the time length of the first time window included in the configuration information is 3 TOs, and the start time unit of the first time window based on the protocol pre-definition is: a target TO, in which a time interval between the target TO and the TO where the CG PUSCH carrying the indication information is located meets a preset duration (e.g., a time interval between a start time of the target TO and an end time of the TO where the CG PUSCH carrying the indication information is located meets a preset duration). In the case that the target TO is TO5, it may be determined that the first time window includes TO5, TO6, and TO7.

Alternatively, in another embodiment of the disclosure, the configuration information may include at least one of: the end time unit of the first time window, or the time length of the first time window.

For example, in an embodiment of the disclosure, the configuration information may include the end time unit and the time length of the first time window. The terminal may determine the first time window based on the end time unit and the time length of the first time window.

For example, in another embodiment of the disclosure, the configuration information may include the end time unit, and the terminal may determine the time length of the first time window based on the protocol pre-definition. Then, the terminal determines the first time window based on the end time unit and the time length of the first time window.

For example, in another embodiment of the disclosure, the configuration information may include the time length of the first time window, and the terminal may determine the end time unit of the first time window based on the protocol pre-definition. Then, the terminal determines the first time window based on the end time unit and the time length of the first time window.

Alternatively, in another embodiment of the disclosure, the configuration information may include at least one of: a reference time unit, an offset time unit, or the time length of the first time window.

For example, in an embodiment of the disclosure, the configuration information may include the reference time unit, the offset time unit, and the time length of the first time window. The terminal may determine the first time window based on the reference time unit, the offset time unit, and the time length of the first time window. For example, the terminal may determine the start time unit or the end time unit of the first time window based on the reference time unit and the offset time unit. For example, the start time unit or the end time unit of the first time window may be equal to: a sum of the reference time unit and the offset time unit. Then, the first time window may be determined based on the start time unit or the end time unit of the first time window in combination with the time length of the first time window.

For example, in another embodiment of the disclosure, the configuration information may include any one or two of: the reference time unit, the offset time unit, and the time length of the first time window, and the reference time unit, the offset time unit, or the time length of the first time window not included in the configuration information may be determined based on the protocol pre-definition. Then, the network device may determine the first time window based on the reference time unit, the offset time unit, and the time length of the first time window.

For example, the offset time unit included in the configuration information is 1 TO and the time length of the first time window is 5 TOs, and the reference time unit determined based on the protocol pre-definition is the TO where the CG PUSCH carrying the indication information is located. It is assumed that the TO where the CG PUSCH carrying the indication information is located is TO0. The start time unit of the first time window may be determined as TO1 based on the reference time unit “TO0” and the offset time unit “1 TO”, and in combination with the time length of the first time window “5 TOs”, it may be determined that the first time window includes TO1, TO2, TO3, TO4, and TO5.

Alternatively, it should be noted that determining the first time window in the disclosure aims to use the indication information to indicate the usage status of the TOs in the first time window. The TOs are TOs in the CG period for uplink transmission, configured by the network device for the terminal. Thus, it should be ensured that resources in the first time window determined are all resources for the uplink transmission, that is, the first time window determined should not include time units for downlink transmission. Alternatively, the time units for the downlink transmission may include at least one of: a downlink time-domain symbol or a downlink slot.

In addition, it should be noted that the time window in the disclosure is merely an exemplary name, and may also be called time range, or time duration, etc. It should be understood that other terms similar to the “time window, time range, time duration” are also within the protection scope of the disclosure.

At block 302, the indication information is sent to the network device based on a usage status of a TO in the first time window, in which the indication information indicates the usage status of the TO located in the first time window.

Alternatively, in an embodiment of the disclosure, the indication information may indicate the usage status of all TOs in the first time window. Alternatively, the first time window may be divided into at least one sub-time window, and the indication information indicates a usage status of a TO in each sub-time window respectively, in which the usage status of the TOs in different sub-time windows may be the same or different. This part will be described in detail in subsequent embodiments.

In conclusion, with the indication method according to the embodiments of the disclosure, the method for determining the time window is provided, such that the indication information may indicate the usage status of the TOs in the time window, thus ensuring a successful indication of the usage status of the TO corresponding to the terminal, and further ensuring the successful reuse of the unused TO and ensuring the efficiency of the uplink transmission.

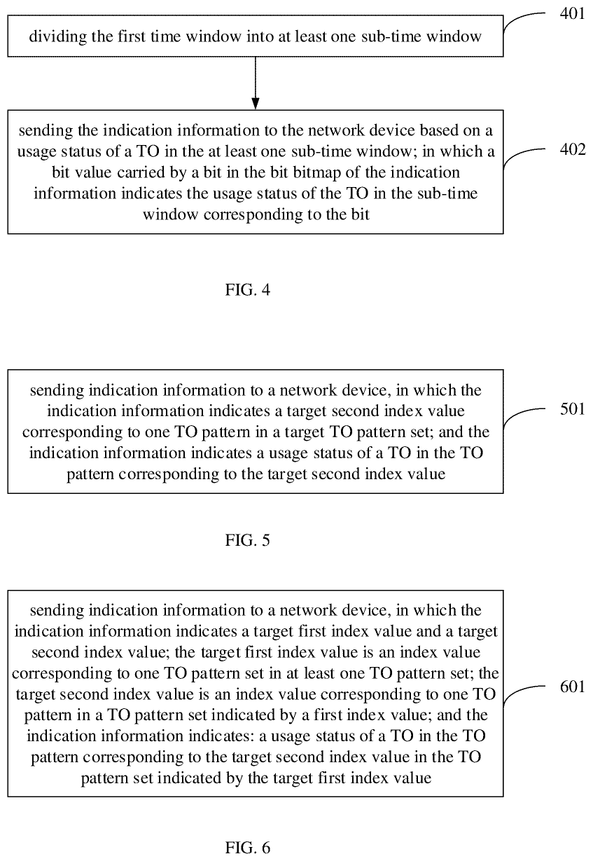

FIG. 4 is a flow chart illustrating an indication method according to an embodiment of the disclosure. The method is executed by a terminal. As illustrated in FIG. 4, the indication method may include the following.

At block 401, a first time window is divided into at least one sub-time window.

Alternatively, embodiments in FIG. 4 are used to introduce a specific process of the method for “dividing the first time window into the at least one sub-time window and using indication information to respectively indicate a usage status of a TO in each sub-time window”.

Alternatively, in an embodiment of the disclosure, the indication information may include a bit bitmap, and a number of sub-time windows divided at block 401 is less than or equal to a number of bits in the bit bitmap, and each sub-time window corresponds to one bit in the bit bitmap. For example, a first bit in high-order bits of the bit bitmap may correspond to a first sub-time window in a time order, a second bit in the high-order bits of the bit bitmap may correspond to a second sub-time window in the time order, and so on. Alternatively, a first bit in low-order bits of the bit bitmap may correspond to a first sub-time window in the time order, a second bit in the low-order bits of the bit bitmap may correspond to a second sub-time window in time order, and so on.

Alternatively, in an embodiment of the disclosure, “dividing the first time window into at least one sub-time window” may include: determining a time length of one sub-time window based on protocol pre-definition and/or configuration of the network device, and dividing the first time window into the at least one sub-time window based on the time length of the sub-time window. Alternatively, when the terminal determines a time length of one time window based on the configuration of the network device, the network device may send second configuration signaling (e.g., RRC signaling (XRgranularity)) to the terminal. The second configuration signaling may indicate the time length of one sub-time window, for example, the time length of one sub-time window may be 1 TO or 2 TOs.

For example, when the first time window includes 8 TOs, and if the time length of one sub-time window determined based on the protocol pre-definition and/or the configuration of the network device is 1 TO, the first time window may be divided into 8 sub-time windows. If the time length of one sub-time window determined based on the protocol pre-definition and/or the configuration of the network device is 2 TOs, the first time window may be divided into 4 sub-time windows.

Alternatively, in another embodiment of the disclosure, “dividing the first time window into at least one sub-time window” may include: flexibly calculating, by the terminal, the time length of the at least one sub-time window based on a number of bits in the bit bitmap of the indication information. For example, the terminal may calculate the time length of the at least one sub-time window by using any one of the following ways:
determining a time length of first

$$N - [ M - ⌊ \frac{M}{N} ⌋ \times N ]$$

sub-time windows as └M/N┘, and determining a time length of last

$$M - ⌊ \frac{M}{N} ⌋ \times N$$

sub-time windows as ┌M/N┐; or
determining a time length of first

$$N - [ M - ⌊ \frac{M}{N} ⌋ \times N ]$$

sub-time windows as └M/N┘, and determining a time length of remaining sub-time windows as ┌M/N┐; or
determining a time length of last

$$N - [ M - ⌊ \frac{M}{N} ⌋ \times N ]$$

sub-time windows as └M/N┘, and determining a time length of first

$$M - ⌊ \frac{M}{N} ⌋ \times N$$

sub-time windows as ┌M/N┐; or
determining a time length of last

$$N - [ M - ⌊ \frac{M}{N} ⌋ \times N ]$$

sub-time windows as └M/N┘, and determining a time length of remaining sub-time windows as ┌M/N┐;
determining a time length of first

$$M - ⌊ \frac{M}{N} ⌋ \times N$$

sub-time windows as └M/N┘, and determining a time length of remaining sub-time windows as ┌M/N┐;
in which ┌·┐ is a ceiling function, and └·┘ is a floor function.

For example, it is assumed that the bit bitmap of the indication information includes 3 bits, and the first time window includes 10 TOs, the terminal may use the way above to divide the first time window into four sub-time windows, in which time lengths of the first three sub-time windows are 3 TOs, and a time length of the last sub-time windows is 1 TO.

At block 402, the indication information is sent to the network device based on a usage status of a TO in the at least one sub-time window.

Alternatively, in an embodiment of the disclosure, a bit value carried by a bit in the bit bitmap of the indication information may indicate the usage status of the TO in the sub-time window corresponding to the bit. For example, when a bit value carried by a certain bit is a first value (such as, 1), it may indicate that the usage status of the TO in the sub-time window corresponding to the bit is “unused”. When the bit value carried by the certain bit is a second value (such as, 0), it may indicate that the usage status of the TO in the sub-time window corresponding to the bit is “used”.

In conclusion, with the indication method according to the embodiments of the disclosure, the method for determining the time window is provided, such that the indication information may indicate the usage status of the TO in the time window, thus ensuring the successful indication of the usage status of the TO corresponding to the terminal, and further ensuring the successful reuse of the unused TO and ensuring the efficiency of the uplink transmission.

FIG. 5 is a flow chart illustrating an indication method according to an embodiment of the disclosure. The method is executed by a terminal. As illustrated in FIG. 5, the indication method may include the following.

At block 501, indication information is sent to a network device, in which the indication information may indicate a target second index value corresponding to one TO pattern in a target TO pattern set; and the indication information may indicate a usage status of a TO in the TO pattern corresponding to the target second index value.

Alternatively, in an embodiment of the disclosure, the terminal may include at least one TO pattern set. The at least one TO pattern set may include at least one TO pattern, and the at least one TO pattern may include at least one TO; in which different TO pattern sets correspond to different first index values, and different TO patterns in the same TO pattern set correspond to different second index values.

Alternatively, the at least one TO pattern set may be pre-defined by a protocol and/or configured for the terminal by the network device. The TO pattern set may be in the form of a table. The TO pattern in the above TO pattern set may be understood as each row in the table, in which each row in the table includes different TOs. The first index value may be understood as a table index, and the second index value may be understood as a row index.

For example, Table 1 is a schematic table of the TO pattern set provided in embodiments of the disclosure.

TABLE 1

| second index value | TO pattern |
|---|---|
| 0 | TO0 TO1 |
| 1 | TO1 TO2 |
| 2 | TO0 TO3 |
| 3 | TO0 TO1 TO2 TO3 |

As illustrated in Table 1, a TO pattern corresponding to the second index value “0” is: TO0 and TO1; a TO pattern corresponding to the second index value “1” is: TO0 and TO2.

Alternatively, in an embodiment of the disclosure, the above target TO pattern set is a certain TO pattern set in the at least one TO pattern set of the terminal. Alternatively, the target TO pattern set may be pre-defined by the protocol and/or pre-configured by the network device.

Alternatively, in an embodiment of the disclosure, the indication information may be the bit value, and the bit value may indicate the target second index value corresponding to one TO pattern in the target TO pattern set. For example, in an embodiment of the disclosure, it is assumed that the protocol pre-defines the TO pattern set illustrated in Table 1 is the target TO pattern set, and the indication information is: bit value 10, in which the indication information is a binary number, and the first index value is a decimal number, binary indication information “10” is converted to a decimal to obtain a decimal number “2”. Thus, the indication information “10” is used to indicate the first index value “2”. It may be understood that the indication information “10” indicates the first index value “2”. Thus, the indication information indicates a usage status of TO0 and TO3. In this case, in the case that it is defined that the indication information indicates unused TOs, when the indication information indicates the bit value as 10, it indicates that TO0 and TO3 are unused TOs. In the case that it is defined that the indication information indicates used TOs, when the indication information indicates the bit value as 10, it indicates that TO0 and TO3 are used TOs.

In conclusion, with the indication method according to the embodiments of the disclosure, the indication information indicates different index values. Different index values are used to support different TO patterns, each TO pattern includes the at least one TO, and the indication information indicates the usage status of the TO in the TO pattern corresponding to the index value indicated by the indication information. It may be known that, the method in the embodiments may indicate the usage status of multiple TOs by using only a small number of bit values, with a low signaling overhead. Meanwhile, the method in embodiments of the disclosure may also flexibly set the relationship between the index value and the TO pattern, providing a high flexibility.

FIG. 6 is a flow chart illustrating an indication method according to an embodiment of the disclosure. The method is executed by a terminal. As illustrated in FIG. 6, the indication method may include the following.

At block 601, indication information is sent to a network device, in which the indication information indicates a target first index value and a target second index value; the target first index value is an index value corresponding to one TO pattern set in at least one TO pattern set; the target second index value is an index value corresponding to one TO pattern in a TO pattern set indicated by a first index value; and the indication information indicates: a usage status of a TO in the TO pattern corresponding to the target second index value in the TO pattern set indicated by the target first index value.

Alternatively, related descriptions of “TO pattern set” and “TO pattern”, may refer to the descriptions in the above embodiments.

Alternatively, the difference between the embodiments of FIG. 6 and the above embodiments of FIG. 5 is the following. In the embodiments of FIG. 5, a target TO pattern set has been pre-defined by the protocol and/or configured by the network device in the at least one TO pattern set of the terminal, that is, both the terminal and the network device know a TO pattern in a TO pattern set to be indicated. Thus, the indication information sent by the terminal to the network device may only indicate the target second index value corresponding to a certain TO pattern in the target TO pattern set, and does not need to include the first index value corresponding to the TO pattern set. In the embodiments of FIG. 6, the target TO pattern set is not pre-defined in the at least one TO pattern set of the terminal, but is autonomously determined by the terminal which TO pattern set the terminal indicates. Thus, the indication information sent by the terminal needs to indicate the target first index value and the target second index value, in which the target first index value indicates a TO pattern set selected by the terminal, and the target second index value indicates a TO pattern in the TO pattern set selected by the terminal, such that the network device may determine the TO pattern set selected by the terminal based on the target first index value, and further determine a specific TO pattern in the TO pattern set is indicated by the terminal based on the target second index value, thus determining the usage status of the TO in the TO pattern.

In addition, a detailed description of block 601 may refer to the description of the above embodiments in FIG. 5.

In conclusion, with the indication method according to the embodiments of the disclosure, the indication information indicates different index values, in which different index values are used to support different TO patterns, each TO pattern includes the at least one TO, and the indication information indicates the usage status of the TO in the TO pattern corresponding to the index value indicated by the indication information. It may be understood that the method in the embodiments may indicate the usage status of the multiple TOs by using only a small number of bit values, with a low signaling overhead. Meanwhile, the method in the embodiments of the disclosure may also flexibly set the relationship between the index value and the TO pattern, providing a high flexibility.

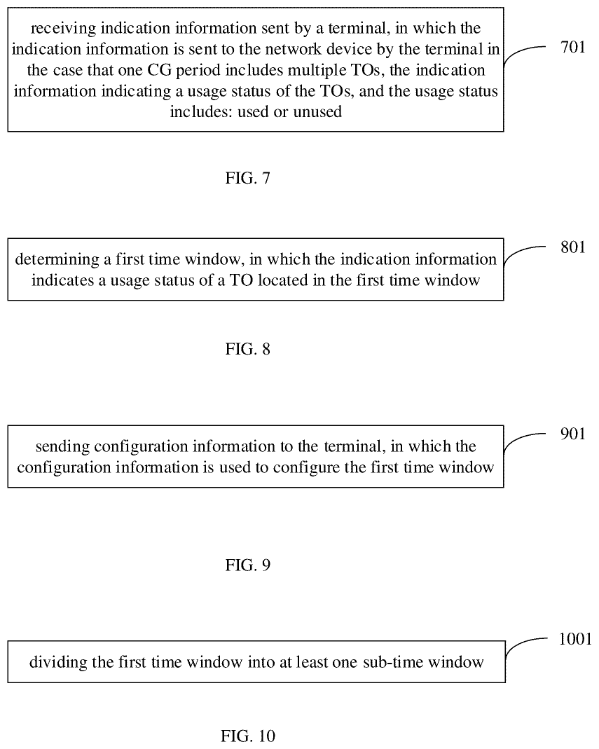

FIG. 7 is a flow chart illustrating an indication method according to an embodiment of the disclosure. The method is executed by a network device. As illustrated in FIG. 7, the indication method may include the following block 701.

At block 701, indication information sent by a terminal is received, in which the indication information is sent to the network device by the terminal in the case that one CG period includes multiple TOs, the indication information indicates a usage status of the TOs, and the usage status includes: used or unused.

A detailed description about block 701 may be referred to the above embodiments.

In conclusion, with the indication method according to the embodiments of the disclosure, the network device receives the indication information sent by the terminal. The indication information is sent to the network device by the terminal in the case that one CG period includes the multiple TOs, the indication information indicates the usage status of the TOs, and the usage status includes: used or unused. Thus, it can be known that, the indication method provided by the disclosure is used for the terminal to indicate the usage status of the TOs in the CG period to the network device, thus the network device may reuse the unused TOs for other uplink transmissions after learning about the TOs in the CG period that are not used by the terminal, thus ensuring the efficiency of the uplink transmission.

FIG. 8 is a flow chart illustrating an indication method according to an embodiment of the disclosure. The method is executed by a network device. As illustrated in FIG. 8, the indication method may include the following.

At block 801, a first time window is determined, in which the indication information indicates a usage status of a TO located in the first time window.

Alternatively, in an embodiment of the disclosure, the network device may autonomously determine the first time window and/or determine the first time window based on protocol pre-definition.

The first time window may include:
one CG period; or,
at least two CG periods overlapped in a time domain; or,
at least two CG periods non-overlapped in a time domain; or,
at least one TO; or,
at least one radio frame; or,
at least one radio half-frame; or,
at least one time-domain symbol; or,
at least one slot.

Alternatively, in an embodiment of the disclosure, the network device may autonomously determine at least one of: a start time unit of the first time window, or an end time unit of the first time window. Further, each not autonomously determined by the network device in the start time unit of the first time window and the end time unit of the first time window may be determined based on the protocol pre-definition.

Alternatively, in an embodiment of the disclosure, the network device may autonomously determine at least one of: the start time unit of the first time window, or a time length of the first time window. Further, each not autonomously determined by the network device in the start time unit of the first time window and the time length of the first time window may be determined based on the protocol pre-definition.

Alternatively, in an embodiment of the disclosure, the network device may autonomously determine at least one of: the end time unit of the first time window, or the time length of the first time window. Further, each not autonomously determined by the network device among the end time unit of the first time window and the time length of the first time window may be determined based on the protocol pre-definition;

Alternatively, in an embodiment of the disclosure, the network device may autonomously determine at least one of: a reference time unit, an offset time unit, or the time length of the first time window. Further, each not autonomously determined by the network device among the reference time unit, the offset time unit, and the time length of the first time window may be determined based on the protocol pre-definition.

A detailed description about block 801 may be referred to the above embodiments.

In conclusion, with the indication method according to the embodiments of the disclosure, the indication method is provided for the terminal to indicate the usage status of the TOs in the CG period to the network device. Thus, the network device may reuse the unused TOs for other uplink transmissions after learning about the TOs in the CG period that are not used by the terminal, thus ensuring the efficiency of the uplink transmission.

FIG. 9 is a flow chart illustrating an indication method according to an embodiment of the disclosure. The method is executed by a network device. As illustrated in FIG. 9, the indication method may include the following.

At block 901, configuration information is sent to a terminal, in which the configuration information configures a first time window.

A detailed description of block 901 may be referred to the above embodiments.

In conclusion, with the indication method according to the embodiments of the disclosure, the indication method is provided for the terminal to indicate the usage status of the TOs in the CG period to the network device, thus the network device may reuse the unused TOs for other uplink transmissions after learning about the TOs in the CG period that are not used by the terminal, thus ensuring the efficiency of the uplink transmission.

FIG. 10 is a flow chart illustrating an indication method according to an embodiment of the disclosure. The method is executed by a network device. As illustrated in FIG. 10, the indication method may include the following.

At block 1001, a first time window is divided into at least one sub-time window.

Alternatively, dividing the first time window into the at least one sub-time window includes:
determining a time length of one sub-time window autonomously by the network device and/or based on protocol pre-definition; and
dividing the first time window into the at least one sub-time window based on the time length of the sub-time window.

Alternatively, in response to determining the time length of one sub-time window autonomously by the network device, the method further includes:
configuring the time length of one sub-time window for the terminal.

Alternatively, dividing the first time window into the at least one sub-time window includes:
determining a time length corresponding to each of the at least one sub-time window based on a number N of bits in the bit bitmap of the indication information and a number M of time units included in the first time window, in which different sub-time windows correspond to a same or different time lengths; and
dividing the first time window into the at least one sub-time window based on the time length of the at least one sub-time window.

A detailed description of block 1001 may be referred to the above embodiments.

In conclusion, with the indication method according to the embodiments of the disclosure, the indication method is provided for the terminal to indicate the usage status of the TOs in the CG period to the network device, thus the network device may reuse the unused TOs for other uplink transmissions after learning about which TOs in the CG period are not used by the terminal, thus ensuring the efficiency of the uplink transmission.

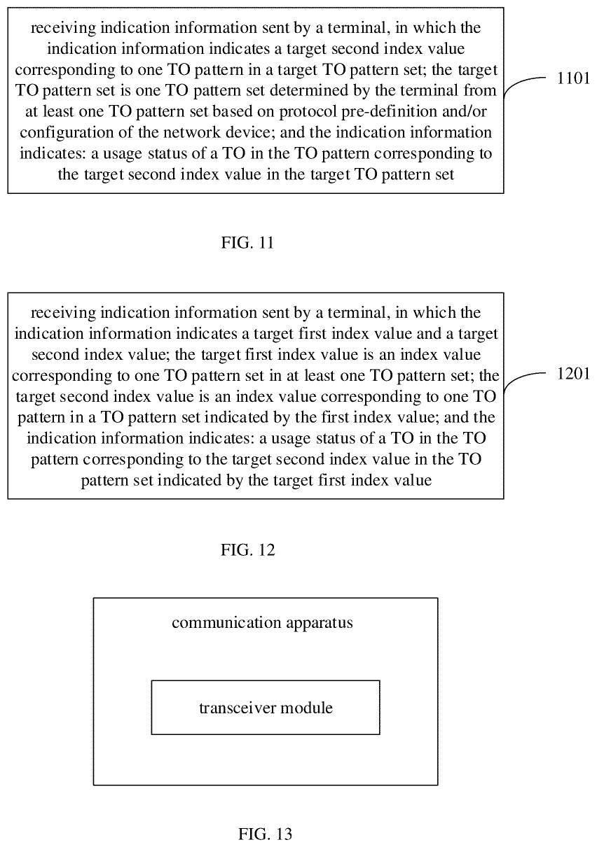

FIG. 11 is a flow chart illustrating an indication method according to an embodiment of the disclosure. The method is executed by a network device. As illustrated in FIG. 11, the indication method may include the following.

At block 1101, indication information sent by a terminal is received, in which the indication information indicates a target second index value corresponding to one TO pattern in a target TO pattern set; the target TO pattern set is one TO pattern set determined by the terminal from at least one TO pattern set based on protocol pre-definition and/or configuration of the network device; and the indication information indicates: a usage status of a TO in the TO pattern corresponding to the target second index value in the target TO pattern set.

A detailed description of block 1101 may be referred to the above embodiments.

In conclusion, with the indication method according to the embodiments of the disclosure, the indication method is provided for the terminal to indicate the usage status of the TOs in the CG period to the network device, thus the network device may reuse the unused TOs for other uplink transmissions after learning about which TOs in the CG period are not used by the terminal, thus ensuring the efficiency of the uplink transmission.

FIG. 12 is a flow chart illustrating an indication method according to an embodiment of the disclosure. The method is executed by a network device. As illustrated in FIG. 12, the indication method may include the following.

At block 1201, indication information sent by a terminal is received, in which the indication information indicates a target first index value and a target second index value; the target first index value is an index value corresponding to one TO pattern set in at least one TO pattern set; the target second index value is an index value corresponding to one TO pattern in the TO pattern set indicated by the first index value; and the indication information indicates: a usage status of a TO in the TO pattern corresponding to the target second index value in the TO pattern set indicated by the target first index value.

A detailed description of block 1201 may be referred to the above embodiments.

In conclusion, with the indication method according to the embodiments of the disclosure, the indication method is provided for the terminal to indicate the usage status of the TOs in the CG period to the network device, thus the network device may reuse the unused TOs for other uplink transmissions after learning about which TOs in the CG period are not used by the terminal, thus ensuring the efficiency of the uplink transmission.

FIG. 13 is a block diagram illustrating a communication apparatus according to an embodiment of the disclosure. As illustrated in FIG. 13, the apparatus may include:
a transceiver module, configured to, in response to one CG period including multiple TOs, send indication information to a network device, in which the indication information indicates a usage status of the TOs, and the usage status includes: used or unused.

In conclusion, in the communication apparatus according to the embodiments of the disclosure, when one CG period includes the multiple TOs, the terminal sends the indication information to the network device, in which the indication information indicates the usage status of the TOs, and the usage status includes: used or unused. It can be known that the indication method provided in the disclosure is used for the terminal to indicate the usage status of the TOs in the CG period to the network device, thus the network device may reuse the unused TOs for other uplink transmissions after learning about which TOs in the CG period are not used by the terminal, thus ensuring the efficiency of the uplink transmission.

Alternatively, in an embodiment of the disclosure, the transceiver module is further configured to:
determine a first time window; and
send the indication information to the network device based on a usage status of a TO in the first time window, in which the indication information indicates the usage status of the TO located in the first time window.

Alternatively, in an embodiment of the disclosure, the transceiver module is further configured to:
determine the first time window based on protocol pre-definition and/or configuration of the network device.

The first time window includes:
one CG period; or,
at least two CG periods overlapped in a time domain; or,
at least two CG periods non-overlapped in a time domain; or,
at least one TO; or,
at least one radio frame; or,
at least one radio half-frame; or,
at least one time-domain symbol; or,
at least one slot.

Alternatively, in an embodiment of the disclosure, the transceiver module is further configured to:
receive configuration information sent by the network device, in which the configuration information includes at least one of: a start time unit of the first time window, an end time unit of the first time window, a time length of the first time window, a reference time unit, or an offset time unit; and
determine the first time window based on the configuration information.

Alternatively, in an embodiment of the disclosure, the transceiver module is further configured to:
in response to the configuration information including the start time unit and the end time unit, determine the first time window based on the start time unit and the end time unit;
in response to the configuration information including the start time unit, determine the end time unit of the first time window based on protocol pre-definition, and determine the first time window based on the start time unit and the end time unit;
in response to the configuration information including the end time unit, determine the start time unit of the first time window based on protocol pre-definition, and determine the first time window based on the start time unit and the end time unit;
in response to the configuration information including the start time unit and the time length of the first time window, determine the first time window based on the start time unit and the time length of the first time window;
in response to the configuration information including the start time unit, determine the time length of the first time window based on protocol pre-definition, and determine the first time window based on the start time unit and the time length of the first time window;
in response to the configuration information including the time length of the first time window, determine the start time unit of the first time window based on protocol pre-definition, and determine the first time window based on the start time unit and the time length of the first time window;
in response to the configuration information including the end time unit and the time length of the first time window, determine the first time window based on the end time unit and the time length of the first time window;
in response to the configuration information including the end time unit, determine the time length of the first time window based on protocol pre-definition, and determine the first time window based on the end time unit and the time length of the first time window;
in response to the configuration information including the time length of the first time window, determine the end time unit of the first time window based on protocol pre-definition, and determine the first time window based on the end time unit and the time length of the first time window;
in response to the configuration information including the reference time unit, the offset time unit and the time length of the first time window, determine the first time window based on the reference time unit, the offset time unit and the time length of the first time window; and
in response to the configuration information including any one or two of the reference time unit, the offset time unit and the time length of the first time window, determine each of the reference time unit, the offset time unit and the time length of the first time window not included in the configuration information based on protocol pre-definition, to determine the reference time unit, the offset time unit and the time length of the first time window, and determine the first time window based on the reference time unit, the offset time unit and the time length of the first time window.

Alternatively, in an embodiment of the disclosure, the transceiver module is further configured to:
determine the start time unit or the end time unit of the first time window based on the reference time unit and the offset time unit; and
determine the first time window based on the start time unit or the end time unit of the first time window in combination with the time length of the first time window.

Alternatively, in an embodiment of the disclosure, the first time window does not include a time unit for downlink transmission.

Alternatively, in an embodiment of the disclosure, the time unit includes at least one of:
a slot;
a time-domain symbol;
a TO;
a radio half-frame; or
a radio frame.

Alternatively, in an embodiment of the disclosure, the indication information includes a bit bitmap.

The transceiver module is further configured to:
divide the first time window into at least one sub-time window, in which a number of the at least one sub-time window is not greater than a number of bits in the bit bitmap, and each sub-time window corresponds to one bit in the bit bitmap; and
send the indication information to the network device based on a usage status of a TO in the at least one sub-time window; in which a bit value carried by a bit in the bit bitmap of the indication information indicates the usage status of the TO in the sub-time window corresponding to the bit.

Alternatively, in an embodiment of the disclosure, the transceiver module is further configured to:
determine a time length of one sub-time window based on the protocol pre-definition and/or the configuration of the network device; and
divide the first time window into the at least one sub-time window based on the time length of the sub-time window.

Alternatively, in an embodiment of the disclosure, the transceiver module is further configured to:
determine a time length corresponding to each of the at least one sub-time window based on a number N of bits in the bit bitmap of the indication information and a number M of time units included in the first time window, in which different sub-time windows correspond to a same or different time lengths; and
divide the first time window into the at least one sub-time window based on the time length of the at least one sub-time window.

Alternatively, in an embodiment of the disclosure, the transceiver module is further configured to:
determine a time length of first

$$N - [ M - ⌊ \frac{M}{N} ⌋ \times N ]$$

sub-time windows as └M/N┘; determine a time length of last

$$M - ⌊ \frac{M}{N} ⌋ \times N$$

sub-time windows as ┌M/N┐; or
determine a time length of first

$$N - [ M - ⌊ \frac{M}{N} ⌋ \times N ]$$

sub-time windows as └M/N┘, and determine a time length of remaining sub-time windows as ┌M/N┘; or
determine a time length of last

$$N - [ M - ⌊ \frac{M}{N} ⌋ \times N ]$$

sub-time windows as └M/N┘, and determine a time length of first

$$M - ⌊ \frac{M}{N} ⌋ \times N$$

sub-time windows as ┌M/N┐; or
determine a time length of last

$$N - [ M - ⌊ \frac{M}{N} ⌋ \times N ]$$

sub-time windows as └M/N┘, and determine a time length of remaining sub-time windows as ┌M/N┐;
determine a time length of first

$$M - ⌊ \frac{M}{N} ⌋ \times N$$

sub-time windows as └M/N┘, and determine a time length of remaining sub-time windows as ┌M/N┐;
in which ┌·┐ is a ceiling function, and └·┘ is a floor function.

Alternatively, in an embodiment of the disclosure, the terminal includes at least one TO pattern set, one TO pattern set includes at least one TO pattern, and one TO pattern includes at least one TO; different TO pattern sets correspond to different first index values, and different TO patterns in a same TO pattern set correspond to different second index values.

Alternatively, in an embodiment of the disclosure, the indication information indicates a target second index value corresponding to one TO pattern in a target TO pattern set; the target TO pattern set is one TO pattern set determined by the terminal from the at least one TO pattern set based on protocol pre-definition and/or configuration of the network device; and
the indication information indicates: a usage status of a TO in the TO pattern corresponding to the target second index value in the target TO pattern set.

Alternatively, in an embodiment of the disclosure, the indication information indicates a target first index value and a target second index value; the target first index value is an index value corresponding to one TO pattern set in the at least one TO pattern set; the target second index value is an index value corresponding to one TO pattern in the TO pattern set indicated by the first index value; and
the indication information indicates: a usage status of a TO in the TO pattern corresponding to the target second index value in the TO pattern set indicated by the target first index value.

Alternatively, in an embodiment of the disclosure, the indication information is sent to the network device in any one or more TOs by a UCI signaling.

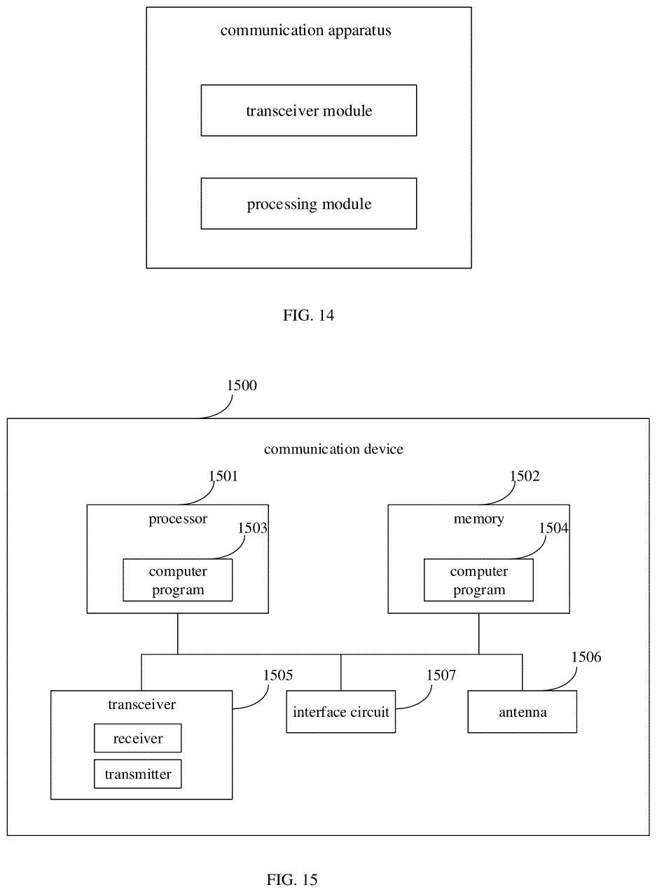

FIG. 14 is a block diagram illustrating a communication apparatus according to an embodiment of the disclosure. As illustrated in FIG. 14, the apparatus may include:
a transceiver module, configured to receive indication information sent by a terminal, in which the indication information is sent to the network device by the terminal in the case that one CG period includes multiple TOs, the indication information indicates a usage status of the TOs, and the usage status includes: used or unused.

In conclusion, with the communication apparatus according to the embodiments of the disclosure, the network device receives the indication information sent by the terminal. The indication information is sent to the network device by the terminal in the case that one CG period includes the multiple TOs, the indication information indicating the usage status of the TOs, and the usage status includes: used or unused. It can be known that, the indication method provided in the disclosure is used for the terminal to indicate the usage status of the TOs in the CG period to the network device, thus the network device may reuse the unused TOs for other uplink transmissions after learning about which TOs in the CG period are not used by the terminal, thus ensuring the efficiency of the uplink transmission.

Alternatively, in an embodiment of the disclosure, the apparatus is further configured to:
determine a first time window, in which the indication information indicates a usage status of a TO located in the first time window.

Alternatively, in an embodiment of the disclosure, the apparatus is further configured to:
determine the first time window autonomously by the network device and/or determine the first time window based on protocol pre-definition.

Alternatively, in an embodiment of the disclosure, the first time window includes:
one CG period; or,
at least two CG periods overlapped in a time domain; or,
at least two CG periods non-overlapped in a time domain; or,
at least one TO; or,
at least one radio frame; or,
at least one radio half-frame; or,
at least one time-domain symbol; or,
at least one slot.

Alternatively, in an embodiment of the disclosure, the apparatus is further configured to:
send configuration information to the terminal, in which the configuration information is used to configure the first time window.

Alternatively, in an embodiment of the disclosure, the configuration information includes at least one of: a start time unit of the first time window, an end time unit of the first time window, a time length of the first time window, a reference time unit, or an offset time unit.

Alternatively, in an embodiment of the disclosure, the indication information includes a bit bitmap.

The apparatus is further configured to:
divide the first time window into at least one sub-time window, in which a number of the at least one sub-time window is not greater than a number of bits in the bit bitmap, and each sub-time window corresponds to one bit in the bit bitmap, and a bit value carried by a bit in the bit bitmap of the indication information indicates the usage status of the TO in the sub-time window corresponding to the bit.

Alternatively, in an embodiment of the disclosure, the apparatus is further configured to:
determine a time length of one sub-time window autonomously by the network device and/or based on the protocol pre-definition; and
divide the first time window into the at least one sub-time window based on the time length of the sub-time window;
in response to determining the time length of one sub-time window autonomously by the network device, the method further includes:
configuring the time length of one sub-time window for the terminal.

Alternatively, in an embodiment of the disclosure, the apparatus is further configured to:
determine a time length corresponding to each of the at least one sub-time window based on a number N of bits in the bit bitmap of the indication information and a number M of time units included in the first time window, in which different sub-time windows correspond to a same or different time lengths; and
divide the first time window into the at least one sub-time window based on the time length of the at least one sub-time window.

Alternatively, in an embodiment of the disclosure, the apparatus is further configured to:
determine a time length of first

$$N - [ M - ⌊ \frac{M}{N} ⌋ \times N ]$$

sub-time windows as └M/N┘, and determine a time length of last

$$M - ⌊ \frac{M}{N} ⌋ \times N$$

sub-time windows as ┌M/N┐; or
determine a time length of first

$$N - [ M - ⌊ \frac{M}{N} ⌋ \times N ]$$

sub-time windows as └M/N┘, and determine a time length of remaining sub-time windows as ┌M/N┐; or
determine a time length of last

$$N - [ M - ⌊ \frac{M}{N} ⌋ \times N ]$$

sub-time windows as └M/N┘, and determine a time length of first sub-time windows as ┌M/N┐; or
determine a time length of last

$$M - ⌊ \frac{M}{N} ⌋ \times N$$

sub-time windows as ┌M/N┐; or
determine a time length of last

$$N - [ M - ⌊ \frac{M}{N} ⌋ \times N ]$$

sub-time windows as └M/N┘, and determine a time length of remaining sub-time windows as ┌M/N┐;
determine a length of first

$$M - ⌊ \frac{M}{N} ⌋ \times N$$

sub-time windows as └M/N┘, and determine a time length of remaining sub-time windows as ┌M/N┐;
in which ┌·┐ is a ceiling function, and └·┘ is a floor function.

Alternatively, in an embodiment of the disclosure, the terminal includes at least one TO pattern set, one TO pattern set includes at least one TO pattern, and one TO pattern includes at least one TO; different TO pattern sets correspond to different first index values, and different TO patterns in a same TO pattern set correspond to different second index values.

Alternatively, in an embodiment of the disclosure, the indication information indicates a target second index value corresponding to one TO pattern in a target TO pattern set; the target TO pattern set is one TO pattern set determined by the terminal from the at least one TO pattern set based on protocol pre-definition and/or configuration of the network device; and
the indication information indicates: a usage status of a TO in the TO pattern corresponding to the target second index value in the target TO pattern set.

Alternatively, in an embodiment of the disclosure, the indication information indicates a target first index value and a target second index value; the target first index value is an index value corresponding to one TO pattern set in the at least one TO pattern set; the target second index value is an index value corresponding to one TO pattern in the TO pattern set indicated by the first index value; and
the indication information indicates: a usage status of a TO in the TO pattern corresponding to the target second index value in the TO pattern set indicated by the target first index value.

FIG. 15 is a block diagram illustrating a communication device 1500 according to an embodiment of the disclosure. The communication device 1500 may be a base station, a terminal, a chip, a system on chip or a processor that supports the base station to implement the above method, or a chip, a system on chip or a processor that supports the terminal to implement the above method. The communication device may be configured to implement the method described in the method embodiments, which may refer to descriptions in the method embodiments.

The communication device 1500 may include one or more processors 1501.

The processor 1501 may include a general purpose processor or a dedicated processor. For example, the processor may be a baseband processor or a central processor. The baseband processor may be configured to process a communication protocol and communication data, and the central processor may be configured to control a communication device (e.g., a base station, a baseband chip, a terminal, a terminal chip, a DU or CU, etc.), to execute a computer program, and process data of the computer program.

Alternatively, the communication device 1500 may further include one or more memories 1502 with a computer program 1504 stored. The computer program 1504 is executed by the processor 1501 to enable the communication device 1500 to execute the method as described in the above method embodiments. Alternatively, the memory 1502 may further store data. The communication device 1500 and the memory 1502 may be independently configured or integrated together.

Alternatively, the communication device 1500 may further include a transceiver 1505 and an antenna 1506. The transceiver 1505 may be referred to as a transceiving unit, a transceiver or a transceiving circuit, which may be configured to realize a transceiving function. The transceiver 1505 may include a receiver and a transmitter. The receiver may be referred to as a receiver or a receiving circuit, etc., for realizing a receiving function; the transmitter may be referred to as a transmitter or a transmitting circuit, etc. for realizing a transmitting function.

Alternatively, the communication device 1500 may further include one or more interface circuits 1507. The interface circuit 1507 is configured to receive code instructions and transmit the code instructions to the processor 1501. The processor 1501 runs the code instructions to enable the communication device 1500 to execute the method as described in the above method embodiments.

In an implementation, the processor 1501 may include a transceiver configured to realize receiving and transmitting functions. For example, the transceiver may be a transceiving circuit, or an interface, or an interface circuit. The transceiving circuit for realizing the receiving and transmitting functions, the interface or the interface circuit may be separate or integrated together. The transceiving circuit, the interface or the interface circuit may be configured to read and write codes/data, or the transceiving circuit, the interface or the interface circuit may be configured to transmit or deliver a signal.

In an implementation, the memory 1502 may be stored with a computer program 1503. The computer program 1503 is running on the processor 1501, to enable the communication device 1500 to execute the method as described in the above method embodiments. The computer program 1503 may be solidified in the processor 1501, in which case the processor 1501 may be realized by hardware.

In an implementation, the communication device 1500 may include a circuit that may realize a transmitting or receiving or communication function in the above method embodiments. The processor and the transceiver described in the disclosure may be realized on integrated circuits (ICs), analog ICs, radio frequency integrated circuits (RFICs), mixed signal ICs, application specific integrated circuits (ASICs), printed circuit boards (PCBs), electronic devices, etc. The processor and the transceiver may further be fabricated by using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe) and gallium arsenide (GaAs).

The communication device described in the above embodiments may be a base station or a terminal, but the scope of the communication device described in the disclosure is not limited, and a structure of the communication device may not be limited by FIG. 15. The communication device may be a stand-alone device or may be a part of a larger device. For example, the communication device may be:
(1) a stand-alone integrated circuit (IC), or a chip, or a system on chip or a subsystem;
(2) a set of one or more ICs, alternatively, which may also include a storage component for storing data and a computer program;
(3) an ASIC, such as a Modem;
(4) a module that may be embedded within other devices;
(5) a receiver, a terminal, a smart terminal device, a cellular phone, a wireless device, a handset, a mobile unit, a vehicle-mounted device, a base station, a cloud device, an artificial intelligence device, etc.;
(6) others, and so forth.

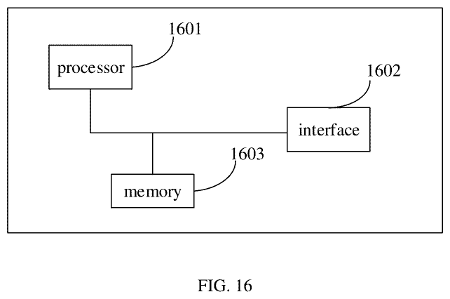

In the case that the communication device may be the chip or the system on chip, a block diagram of a chip illustrated in FIG. 16 may be referred. The chip illustrated in FIG. 16 includes a processor 1601 and an interface 1602. There may be one or more processors 1601, and there may be more interfaces 160.

Alternatively, the chip further includes a memory 1603, configured to save necessary computer program and data.

Those skilled in the related art may understand that, various illustrative logical blocks and steps listed in embodiments of the disclosure, may be realized by electronic hardware, computer software or a combination of the electronic hardware and the computer software. Whether the function is realized by the hardware or the software depends on a specific application and a design requirement of an overall system. Those skilled in the art may realize the functions by using various methods for each specific application, but such an implementation should not be understood as beyond the protection scope of embodiments of the disclosure.

A readable storage medium with instructions stored is also provided in the disclosure. When the instructions are executed by a computer, functions of any one of the above method embodiments are realized.

A computer program product is also provided in the disclosure. The computer program product is configured to realize functions of any one of the above method embodiments when executed by a processor.

In the above embodiments, the functions may be wholly or partially implemented by software, hardware, firmware, or any combination of them. When realized by the software, the functions may be realized in whole or in part in the form of the computer program product. The computer program product includes one or more computer programs. Procedures or functions according to embodiments of the disclosure are wholly or partially generated when the computer program is loaded and executed on a computer. The computer may be a general purpose computer, a special purpose computer, a computer network, or other programmable device. The computer program may be stored in a computer-readable storage medium or transmitted from one computer-readable storage medium to another. For example, the computer program may be transmitted from one website, computer, server, or data center to another via wire (such as a coaxial cable, a fiber optic, a digital subscriber line (DSL)) or wireless (such as infrared, wireless, microwave). The computer-readable storage medium may be any available medium that may be accessed by a computer or a data storage device such as a server that integrates one or more of the available media, and a data center. The readable medium may be a magnetic medium (such as a floppy disk, a hard disk and a magnetic tape), an optical medium (such as a digital video disk (DVD)), or a semiconductor medium (such as a solid state disk (SSD)).

Those skilled in the art may understand that various numbers such as first and second involved in disclosure are distinguished merely for convenience of description, and are not intended to limit the scope of embodiments of the disclosure, but also to indicate an order of precedence.

The term “at least one” in the disclosure may also be described as one or more, and the term “multiple” may refer to two, three, four or more, which is not limited in the disclosure. In embodiments of the disclosure, for a kind of technical feature, technical features in the kind of technical feature are distinguished by “first”, “second”, “third”, “A”, “B”, “C” and “D”, and there is no order of precedence or magnitude between technical features described by “first”, “second”, “third”, “A”, “B”, “C” and “D”.

Corresponding relationships indicated by tables in the disclosure may be configured or predefined. Values of information in tables are only examples, and may be configured as other values, which are not limited in the disclosure. When corresponding relationships between information and parameters are configured, there is not always need to configure all corresponding relationships indicated in tables. For example, in the tables in the disclosure, corresponding relationships indicated by some rows may not be configured. For another example, appropriate transformations and adjustments, such as splitting and merging, may be made based on the above tables. Names of parameters illustrated in headers in the tables may be other names understandable by the communication device, and values or representations of the parameters may be other values or representations understandable by the communication device. When the above tables are realized, other data structures may be used, and for example, arrays, queues, containers, stacks, linear lists, pointers, linked lists, trees, graphs, structures, classes, heaps or hash tables may be used.

Predefined in the disclosure may be understood as defined, predefined, stored, pre-stored, pre-negotiated, pre-configured, solidified or pre-fired.

Those skilled in the related art may realize that, in combination with units and algorithm steps of the examples described in embodiments of the disclosure, may be realized by an electronic hardware or a combination of an electronic hardware and a computer software. Whether the functions are executed by the hardware or the software depends on a specific application and a design constraint of the technical solution. Those skilled in the art may employ different methods for each specific application to realize the described functions, but such realization should not be considered beyond the scope of the disclosure.

Those skilled in the art may clearly understand that, a detailed working process of a system, an apparatus and a unit described above may refer to a corresponding process in the above method embodiments, which will not be repeated here.

The above are only implementations of the disclosure. However, the protection scope of the disclosure is not limited here. Changes and substitutions that may be easily considered by those skilled in the art who is familiar with the technical field shall be contained within the protection scope of the disclosure. Thus, the protection scope of the disclosure shall be subject to the protection scope of claims.

1. An indication method, executed by a terminal, comprising:
in the case that one configured grant (CG) period comprises a plurality of transmission occasions (TOs), sending indication information to a network device, wherein the indication information indicates a usage status of the TOs, and the usage status comprises: used or unused.

2. The method of claim 1, wherein sending the indication information to the network device comprises:
determining a first time window; and
sending the indication information to the network device based on a usage status of a TO in the first time window, wherein the indication information indicates the usage status of the TO located in the first time window.

3. The method of claim 2, wherein determining the first time window comprises:
determining the first time window based on at least one of protocol pre-definition or configuration of the network device;
wherein the first time window comprises:
one CG period; or,
at least two CG periods overlapped in a time domain; or,
at least two CG periods non-overlapped in a time domain; or,
at least one TO; or,
at least one radio frame; or,
at least one radio half-frame; or,
at least one time-domain symbol; or,
at least one slot.

4. The method of claim 2, wherein determining the first time window comprises:
receiving configuration information sent by the network device, wherein the configuration information comprises at least one of: a start time unit of the first time window, an end time unit of the first time window, a time length of the first time window, a reference time unit, or an offset time unit; and
determining the first time window based on the configuration information,
wherein determining the first time window based on the configuration information comprises any one of:
in the case that the configuration information comprises the start time unit and the end time unit, determining the first time window based on the start time unit and the end time unit;
in the case that the configuration information comprises the start time unit, determining the end time unit of the first time window based on protocol pre-definition, and determining the first time window based on the start time unit and the end time unit;
in the case that the configuration information comprises the end time unit, determining the start time unit of the first time window based on protocol pre-definition, and determining the first time window based on the start time unit and the end time unit;
in the case that the configuration information comprises the start time unit and the time length of the first time window, determining the first time window based on the start time unit and the time length of the first time window;
in the case that the configuration information comprises the start time unit, determining the time length of the first time window based on protocol pre-definition, and determining the first time window based on the start time unit and the time length of the first time window;
in the case that the configuration information comprises the time length of the first time window, determining the start time unit of the first time window based on protocol pre-definition, and determining the first time window based on the start time unit and the time length of the first time window;
in the case that the configuration information comprises the end time unit and the time length of the first time window, determining the first time window based on the end time unit and the time length of the first time window;
in the case that the configuration information comprises the end time unit, determining the time length of the first time window based on protocol pre-definition, and determining the first time window based on the end time unit and the time length of the first time window;
in the case that the configuration information comprises the time length of the first time window, determining the end time unit of the first time window based on protocol pre-definition, and determining the first time window based on the end time unit and the time length of the first time window;
in the case that the configuration information comprises the reference time unit, the offset time unit and the time length of the first time window, determining the first time window based on the reference time unit, the offset time unit and the time length of the first time window; and
in the case that the configuration information comprises any one or two of the reference time unit, the offset time unit and the time length of the first time window, determining each of the reference time unit, the offset time unit and the time length of the first time window not comprised in the configuration information based on protocol pre-definition, to determine the reference time unit, the offset time unit and the time length of the first time window, and determining the first time window based on the reference time unit, the offset time unit and the time length of the first time window,
wherein determining the first time window based on the reference time unit, the offset time unit and the time length of the first time window comprises:
determining the start time unit or the end time unit of the first time window based on the reference time unit and the offset time unit; and
determining the first time window based on the start time unit or the end time unit of the first time window in combination with the time length of the first time window.

5-6. (canceled)

7. The method of claim 2, wherein the first time window does not comprise a time unit for downlink transmission,
wherein the time unit comprises at least one of:
a slot;
a time-domain symbol;
a TO;
a radio half-frame; or
a radio frame.

8. (canceled)

9. The method of claim 2, wherein the indication information comprises a bit bitmap; and
sending the indication information to the network device based on the usage status of the TO in the first time window comprises:
dividing the first time window into at least one sub-time window, wherein a number of the at least one sub-time window is not greater than a number of bits in the bit bitmap, and each sub-time window corresponds to one bit in the bit bitmap; and
sending the indication information to the network device based on a usage status of a TO in the at least one sub-time window; wherein a bit value carried by a bit in the bit bitmap of the indication information indicates the usage status of the TO in the sub-time window corresponding to the bit.

10. The method of claim 9, wherein dividing the first time window into the at least one sub-time window comprises one of:
determining a time length of one sub-time window based on the at least one of the protocol pre-definition or the configuration of the network device; and dividing the first time window into the at least one sub-time window based on the time length of the sub-time window; or
determining a time length corresponding to each of the at least one sub-time window based on a number N of bits in the bit bitmap of the indication information and a number M of time units comprised in the first time window, wherein different sub-time windows correspond to a same or different time lengths; and dividing the first time window into the at least one sub-time window based on the time length of the at least one sub-time window-,
wherein determining the time length corresponding to each of the at least one sub-time window based on the number N of bits in the bit bitmap of the indication information and the number M of the time units comprised in the first time window comprises one of:
determining a time length of first
$$N - [ M - ⌊ \frac{M}{N} ⌋ \times N ]$$
sub-time windows as └M/N┘, and determining a time length of last
$$M - ⌊ \frac{M}{N} ⌋ \times N$$
sub-time windows as ┌M/N┐;
determining a time length of first
$$N - [ M - ⌊ \frac{M}{N} ⌋ \times N ]$$
sub-time windows as └M/N┘, and determining a time length of remaining sub-time windows as ┌M/N┐; or
determining a time length of last
$$N - [ M - ⌊ \frac{M}{N} ⌋ \times N ]$$
sub-time windows as └M/N┘, and determining a time length of first
$$M - ⌊ \frac{M}{N} ⌋ \times N$$
sub-time windows as ┌M/N┐;
determining a time length of last
$$N - [ M - ⌊ \frac{M}{N} ⌋ \times N ]$$
sub-time windows as └M/N┘, and determining a time length of remaining sub-time windows as ┌M/N┐; or
determining a time length of first
$$M - ⌊ \frac{M}{N} ⌋ \times N$$
sub-time windows as └M/N┘, and determining a time length of remaining sub-time windows as ┌M/N┐;
wherein ┌·┐ is a ceiling function, and └·┘ is a floor function.

11-12. (canceled)

13. The method of claim 1, wherein the terminal comprises at least one TO pattern set, one TO pattern set comprises at least one TO pattern, and one TO pattern comprises at least one TO; different TO pattern sets correspond to different first index values, and different TO patterns in a same TO pattern set correspond to different second index values.

14. The method of claim 13, wherein the indication information indicates a target second index value corresponding to one TO pattern in a target TO pattern set; the target TO pattern set is one TO pattern set determined by the terminal from the at least one TO pattern set based on at least one of protocol pre-definition or configuration of the network device; and the indication information indicates: a usage status of a TO in the TO pattern corresponding to the target second index value in the target TO pattern set; or
wherein the indication information indicates a target first index value and a target second index value; the target first index value is an index value corresponding to one TO pattern set in the at least one TO pattern set; the target second index value is an index value corresponding to one TO pattern in the TO pattern set indicated by the first index value; and the indication information indicates: a usage status of a TO in the TO pattern corresponding to the target second index value in the TO pattern set indicated by the target first index value.

15. (canceled)

16. The method of claim 1, wherein the indication information is sent to the network device in any one or more TOs by an uplink control information (UCI) signaling.

17. An indication method, executed by a network device, comprising:
receiving indication information sent by a terminal, wherein the indication information is sent to the network device by the terminal in the case that one configured grant (CG) period comprises a plurality of transmission occasions (TOs), the indication information indicates a usage status of the TOs, and the usage status comprises: used or unused.

18. The method of claim 17, further comprising:
determining a first time window, wherein the indication information indicates a usage status of a TO located in the first time window,
wherein determining the first time window comprises:
determining the first time window autonomously by at least one of the network device or protocol pre-definition.

19. (canceled)

20. The method of claim 18, wherein the first time window comprises one of:
one CG period;
at least two CG periods overlapped in a time domain;
at least two CG periods non-overlapped in a time domain;
at least one TO;
at least one radio frame;
at least one radio half-frame;
at least one time-domain symbol; or,
at least one slot.

21. The method of claim 18, further comprising:
sending configuration information to the terminal, wherein the configuration information is used to configure the first time window,
wherein the configuration information comprises at least one of: a start time unit of the first time window, an end time unit of the first time window, a time length of the first time window, a reference time unit, or an offset time unit.

22. (canceled)

23. The method of claim 17, wherein the indication information comprises a bit bitmap; and
the method further comprises:
dividing the first time window into at least one sub-time window, wherein a number of the at least one sub-time window is not greater than a number of bits in the bit bitmap, and each sub-time window corresponds to one bit in the bit bitmap, and a bit value carried by a bit in the bit bitmap of the indication information indicates the usage status of the TO in the sub-time window corresponding to the bit.

24. The method of claim 23, wherein dividing the first time window into the at least one sub-time window comprises one of:
determining a time length of one sub-time window autonomously by the at least one of the network device or based on the protocol pre-definition; and dividing the first time window into the at least one sub-time window based on the time length of the sub-time window; or
determining a time length corresponding to each of the at least one sub-time window based on a number N of bits in the bit bitmap of the indication information and a number M of time units comprised in the first time window, wherein different sub-time windows correspond to a same or different time lengths; and dividing the first time window into the at least one sub-time window based on the time length of the at least one sub-time window,
in response to determining the time length of one sub-time window autonomously by the network device, the method further comprises:
configuring the time length of one sub-time window for the terminal,
wherein determining the time length corresponding to each of the at least one sub-time window based on the number N of bits in the bit bitmap of the indication information and the number M of the time units comprised in the first time window comprises one of:
determining a time length of first
$$N - [ M - ⌊ \frac{M}{N} ⌋ \times N ]$$
sub-time windows as └M/N┘, and determining a length of last
$$M - ⌊ \frac{M}{N} ⌋ \times N$$
sub-time windows as ┌M/N┐;
determining a time length of first
$$N - [ M - ⌊ \frac{M}{N} ⌋ \times N ]$$
sub-time windows as └M/N┘, and determining a time length of remaining sub-time windows as └M/N┘;
determining a time length of last
$$N - [ M - ⌊ \frac{M}{N} ⌋ \times N ]$$
determining a length of first
$$M - ⌊ \frac{M}{N} ⌋ \times N$$
sub-time windows as ┌M/N┐;
determining a time length of last
$$N - [ M - ⌊ \frac{M}{N} ⌋ \times N ]$$
sub-time windows as └M/N┘, and determining a time length of remaining sub-time windows as ┌M/N┐; or
determining a time length of first
$$M - ⌊ \frac{M}{N} ⌋ \times N$$
Sub-time windows as └M/N┘, and determining a time length of remaining sub-time windows as ┌M/N┐;
wherein ┌·┐ is a ceiling function, and └·┘ is a floor function.

25-26. (canceled)

27. The method of claim 17, wherein the terminal comprises at least one TO pattern set, one TO pattern set comprises at least one TO pattern, and one TO pattern comprises at least one TO; different TO pattern sets correspond to different first index values, and different TO patterns in a same TO pattern set correspond to different second index values.

28. The method of claim 27, wherein the indication information indicates a target second index value corresponding to one TO pattern in a target TO pattern set; the target TO pattern set is one TO pattern set determined by the terminal from the at least one TO pattern set based on protocol pre-definition and/or configuration of the network device; and the indication information indicates: a usage status of a TO in the TO pattern corresponding to the target second index value in the target TO pattern set; or
wherein the indication information indicates a target first index value and a target second index value; the target first index value is an index value corresponding to one TO pattern set in the at least one TO pattern set; the target second index value is an index value corresponding to one TO pattern in the TO pattern set indicated by the first index value; and the indication information indicates: a usage status of a TO in the TO pattern corresponding to the target second index value in the TO pattern set indicated by the target first index value.

29. (canceled)

30. A terminal, comprising:
a processor; and
a memory for storing instructions executable by the processor,
wherein the processor is
configured to, in the case that one configured grant (CG) period comprises a plurality of transmission occasions (TOs), send indication information to a network device, wherein the indication information indicates a usage status of the TOs, and the usage status comprises: used or unused.

31. A network device, comprising:
a processor; and
a memory for storing instructions executable by the processor,
wherein the processor is configured to execute the indication method of claim 17.

32-34. (canceled)
